(19) United States
(12) Patent Application Publication
(10) Pub. No.: US 2024/0138326 A1
(43) Pub. Date: May 2, 2024

(54) CONTROL METHOD FOR PREPARING CROP NUTRIENT SOLUTION AND REGULATING DEVICE

(71) Applicant: Fulian Precision Electronics (Tianjin) Co., LTD., Tianjin (CN)

(72) Inventors: YU-SHAN LIN, Taoyuan (TW); CHIEN-HAO SU, Taoyuan (TW); KAI-SIANG YOU, Taoyuan (TW); YAO-WEN TUNG, New Taipei (TW)

(21) Appl. No.: 18/127,545

(22) Filed: Mar. 28, 2023

(30) Foreign Application Priority Data
Oct. 28, 2022 (CN) 202211334317.X

(51) Int. Cl. A01G 31/02; G06T 7/00; G06V 20/68

(52) U.S. Cl. CPC A01G 31/02; G06T 7/0012; G06V 20/68

(57) ABSTRACT

A control method for preparing crop nutrient solution, applied in a regulating device, obtains growth data of crops, and determines a growth state of the crops according to the growth data of the crops. The proportion of the nutrient solution required by the crops is determined according to the growth states of the crops, and the culture solution is adjusted according to the proportion of the nutrient solution. After a preset time period, updated growth state of the crops is determined. When the culture solution does not meet the proportion of the nutrient solution corresponding to the updated growth state, the culture solution is adjusted again until the culture solution meet the proportion of the nutrient solution corresponding to the growth state of the crops.

This application claims priority to Chinese Patent Application No. 202211334317.X filed on Oct. 28, 2022, in China National Intellectual Property Administration, the contents of which are incorporated by reference herein.

### FIELD

The subject matter herein generally relates to an intelligent agricultural technology field, in particular, relates to a control method for preparing crop nutrient solution and a regulating device.

### BACKGROUND

Intelligent plant factories use hydroponics to grow crops without being affected by the climate. However, in a plant factory, the ability to adjust a composition of a culture medium can determine the entire hydroponic cultivation to be a success or a failure. Therefore, there is an urgent need to increase success rate of the intelligent cultivation of plants.

### BRIEF DESCRIPTION OF THE DRAWINGS

Implementations of the present disclosure will now be described, by way of embodiment, with reference to the attached figures.

FIG. 1 is a flowchart of one embodiment of a control method for preparing crop nutrient solution.

FIG. 2 is a schematic of a control device for preparing crop nutrient solution.

FIG. 3 is a structural diagram of one embodiment of a regulating device performing the method of FIG. 2.

### DETAILED DESCRIPTION

In order to clearly understand objects, features and advantages of the present disclosure, the present disclosure will be described in detail below in conjunction with accompanying drawings and specific embodiments. It should be noted that, in the case of no conflict, the embodiments of the present disclosure and the features in the embodiments can be combined with each other.

Many specific details are set forth in the following description to facilitate a full understanding of the disclosure, and the described embodiments are only some of the embodiments of the disclosure, rather than all of the embodiments. Based on the embodiments in the disclosure, all other embodiments obtained by persons of ordinary skill in the art without making creative efforts belong to a scope of protection of the disclosure.

Terms “first”, “second” and “third” in a specification and claims of the present disclosure and the above drawings are used to distinguish different objects, rather than to describe a specific order. Furthermore, a term “comprise”, as well as any variations thereof, is intended to cover a non-exclusive inclusion. For example, a process, a method, a system, a product or a device comprising a series of steps or units is not limited to the listed steps or units, but optionally also includes unlisted steps or units, or optionally further includes other steps or units inherent.

Current smart plant factories use hydroponic cultivation, which is not affected by the climate, so that crops can grow well in all seasons, but current nutrient solution deployment is detected by manual on-site inspection. However, adjusting the nutrient solution by manual on-site inspection is inefficient, requires more manpower, and cannot accurately adjust a proportion of the nutrient solution to make the crops most suitable for the current growth state of the crops in real time.

In order to solve above technical problems, the application provides a control method for preparing crop nutrient solution. The method uses image processing technology and algorithms to automatically determine growth states of crops, and adjust the culture solution in real time according to growth stages and growth states of the crops, so as to adjust the culture solution of the crops efficiently and easily. The control method for preparing crop nutrient solution is applied to one or more regulating devices.

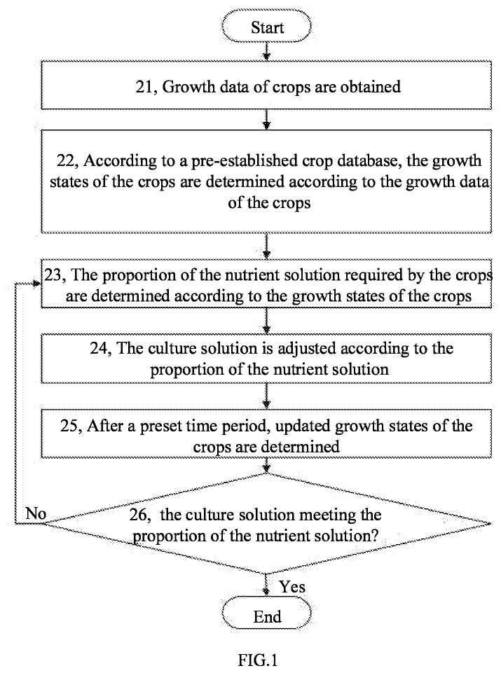

FIG. 1 illustrates a flowchart of one embodiment of the control method for preparing crop nutrient solution. According to different requirements, an order of steps in the flowchart can be changed, and some steps can be omitted.

At block 21, growth data of crops are obtained.

In one embodiment of the present disclosure, the regulating device determining the growth data of the crops includes: detecting a change of a water level in a water tank where the crops are grown. For example, to detect the water level, one or more water level monitors can be arranged in the water tank of the crops to monitor a depth of the culture solution in the water tank in real time. When the water level in the water tank is lower than a preset water level threshold, growth images of the crops are obtained by an image acquisition device (for example an image sensor), the growth images are identified and growth data of the crops is obtained.

In one embodiment, the water level monitor can be a water level sensor, and the water level sensor refers to an instrument that can convert water level parameters of a measured point into corresponding electric power signals in real time. A working principle of the water level sensor includes: transmitting sensed water level signals to a controller of the regulating device, and calculation components in the controller comparing sensed water level signals with a setting signal to obtain a deviation, and then according to a nature of the deviation, an opening command or a closing command is issued to an electric water supply valve to ensure that the water tank reaches a set water level corresponding to the preset water level threshold.

In one embodiment of the present disclosure application, the image acquisition device is set in a crop monitoring area, and the water level sensor sends the sensed water level signal to the regulating device, and the regulating device compares the sensed water level signal and the setting signal to calculate the deviation between the sensed water level signal and the setting signal. When the deviation has a negative value, it indicates that the water level has dropped and is lower than the preset water level threshold. According to the deviation having the negative value, the regulating device sends an opening command to the electric water supply valve, and at the same time sends an image acquisition signal to the image acquisition device. The image acquisition device acquires images of the crops and transmits the images to the regulating device. In other embodiments, the image acquisition device can also monitor the growth of crops in real time, and transmit the images collected in real time to the regulating device, and the regulating device stores the images, and identify the images received after sending an opening command to the electric water supply valve.

The regulating device processing and identifying the images includes: binarizing the images to obtain binarized images; determining a density information of the crops in each planting area according to the binarized images; extracting color parameters of the images corresponding to each planting area, and determining growth cycles and health status of the crops in each planting area according to the color parameters; determining a height information of the crops in each planting area according to a height of the image acquisition device erected and internal parameters and external parameters of the image acquisition device; determining the growth data of the crops corresponding to each planting area according to the density information, the growth cycles and the health status and the height information.

In one embodiment, the color parameters include color values of three primary colors of red, green and blue (Red-Green-Blue, RGB) in the color system. According to the color values of the RGB, it can be determined whether the crops in each planting area are mature. Maturity parameters corresponding to different crop varieties, such as leaf color, bud color, flower color and fruit color, etc., are stored in advance. The color values of the RGB in the images are compared with the maturity parameters of the crop variety to determine a maturity information of the crops in each planting area.

At block 22, according to a pre-established crop database, the growth states of the crops are determined according to the growth data of the crops, and the crop database includes the growth states of various crops in multiple growth stages and a proportion of nutrient solution corresponding to each of the growth states.

In one embodiment, the crop database is built in advance for the crops that need to be planted, and the database includes the growth cycles of the crops and growth conditions corresponding to the growth cycles.

In one embodiment, it can be determined that the growth cycles of the crops are T growth periods (T is a positive integer). For example, taking the growth cycles of the crops including germination, growth, flowering, and fruiting as an example, the growth cycles of the crops can be divided into four growth periods (that is, T is equal to 4). In the four growth periods, a first growth period is a germination period, a second growth period is a growth period, a third growth period is a flowering period, and a fourth growth period is a fruiting period. Each of the growth periods can be selected to correspond to different nutrient solution indicators. The nutrient solution indicators include an electrical conductivity (EC) value and a potential of hydrogen (PH) value, and a preferred EC value range and a preferred PH value range can be set for each of the growth periods of the crops. The above embodiment is just an example, and it can be divided into more or fewer growth periods in practical applications.

In one embodiment, the crop database includes the health status of the crops, including colors and sizes of leaves corresponding to each growth period, a density of branches and leaves, a thickness of stalks and other parameters to characterize the health status of the crops. The optimized proportion of the nutrient solution are determined for different health states.

In one embodiment, the growth data of the crops is compared with the crop data in the crop database to determine the growth states of the crops.

At block 23, the proportion of the nutrient solution required by the crops are determined according to the growth states of the crops.

In one embodiment, the proportion of the nutrient solution includes proportions of one or more culture solutions and sulfuric acid solutions. According to the growth states of the crops, proportions/concentrations of the nutrient solution corresponding to the growth states of the crops is obtained in the crop database. The proportions of one or more culture solutions and sulfuric acid solution are determined according to the obtained proportion of the nutrient solution/concentrations.

For example, the culture solution may include one or more culture solutions and sulfuric acid solutions, all of which are pre-configured culture solutions, and each culture solution contains a preset concentration of nutritional components for crop growth. For example, the nutritional components can include nutrients and trace elements required by the crops, the nutrients can include nitrogen, phosphorus, potassium, calcium, magnesium, sulfur and other elements. The trace elements can include iron, manganese, zinc, copper, molybdenum, elements such as boron and chlorine. By mixing one or more the culture solutions and the sulfuric acid solutions according to a set ratio, the culture solution with the required EC value and PH value can be prepared.

Taking a PH value adjustment as an example, when monitoring that the culture solution of the crops is 10 liters, that the current PH value of the culture solution is 6, and that the target PH value corresponding to the current growth stage of the crops is 5, the sulfuric acid solution can be added, and the PH value of the sulfuric acid solution H2SO4 is 2. First, 100 liters of culture solution A are added to a stirring water tank of the regulating device, and the current PH value of culture solution A is 7. Then, an amount of sulfuric acid solution added to the culture solution A is calculated. A total amount of hydrogen ions (H+) contained in 100 liters of culture solution A and the 10 liters of the culture solution is 100 L*10-7 mol/L+10 L*10-6 mol/L=2*10-5 mol; a target amount of hydrogen ions (H+) is 110 L*10-5 mol/L=110*10-5 mol, so an added amount of hydrogen ions (H+) that needs to be supplemented is calculated according to a following formula: 110*10-5 mol-2*10-5 mol=108*10-5 mol; the amount of hydrogen ions (H+) contained in each liter of the sulfuric acid solution is 2*10-5 mol, so the amount of sulfuric acid solution H2SO4 that needs to be added to the culture solution A is 108*10-5 mol % 2*10-5 mol/L=0.108 L, that is, another 108 ml of the sulfuric acid solution H2SO4 need to be added.

At block 24, the culture solution is adjusted according to the proportion of the nutrient solution.

In one embodiment, the nutrient solution is a culture solution prepared for a certain planted crop and contains a specific nutrient content, and is used to be directly added to the crop culture dish. The culture solution is one or more culture fluids commonly used for preparation.

In one embodiment, a certain amount of water is added to the water tank, and one or more culture solutions and/or preset chemicals are respectively added to the water tank in a preset proportion to realize an adjustment of the culture solution. For example, in one embodiment, one or more culture solutions and chemical substances can be injected into the water tank according to the proportion of the nutrient solution determined in block S23. In one embodiment, 108 milliliters of the sulfuric acid solution are added to 100 liters of culture solution A to obtain 110 liters of the culture solution. After injection, the culture solution in the water tank is stirred by a stirrer, and evenly stirred 110 liters of the culture solution are injected into a crop incubator, and a water cycle was turned on for a preset time period.

In one embodiment, the crops may have a poor growth state before supplementing the culture solution, which may not be current real growth state of the crops. Therefore, after the culture solution is supplemented, the water cycle is turned on and works for a preset time period, so that the crops can only show the real growth states of the crops after fully absorbing the culture solution.

At block 25, after a preset time period, updated growth states of the crops are determined.

After adjusting the culture solution, injecting the culture solution and performing the water cycle for a preset time period, the images of the crops are recaptured, the growth data of the crops is obtained, and updated growth states of the crops is determined according to the growth data of the crops and the crop database. According to the updated growth states, it is determined whether the culture solution of the crops meets the proportions of the nutrient solutions corresponding to the growth states of the crops. In one embodiment, when the proportion of the nutrient solution is within a certain range and corresponds to a preset preferred value, it can be determined whether the culture solution of the crops corresponds to the preferred proportion of the nutrient solution according to the renewed growth state of the crop, and optimal nutrition for crop growth is provided by utilizing optimized proportion of the nutrient solution.

At block 26, the nutrient composition of the culture solution is detected, and whether the culture solution meeting the proportion of the nutrient solution corresponding to the updated growth state is determined. When the culture solution does not meet the proportion of the nutrient solution corresponding to the updated growth state, the method returns to block 23 to adjust the culture solution again until the culture solution meets the proportion of the nutrient solution corresponding to the growth state of the crop.

In one embodiment of the present disclosure, each water tank can be configured with an independent EC value detector, a PH value detector and an automatic switch valve for adding the culture solution. The EC value detector is used to detect an EC value of the culture solution of the crops, and determine whether the EC value of the culture solution is a preferred EC value. The pH detector is used to detect a PH value of the culture solution of the crops, and determine whether the PH value of the culture solution is a preferred PH value.

When the PH value is more than a first default value, the regulating device calculates a target amount of the sulfuric acid solution that needs to be replenished is calculated according to a detected PH value of the PH value detector, and add the sulfuric acid solution with the target amount, and reduce the PH value. When the PH value is less that the first default value, the regulating devices calculates a target amount of the water to be supplemented according to the PH value detected by the PH value detector, and the regulating device will add the water to be supplemented by opening the automatic switch valve for adding the culture solution to increase the PH value. In one embodiment, when the EC value is more than a second default value, the regulating device calculates a second target mount of the water to be supplemented according to the EC value detected by the EC value detector, and the regulating device will add the water with the second target amount by opening the automatic switch valve for adding culture solution, and reduce the EC value. When the EC value is less than the second default value, the regulating device calculates a second target amount of the nutrient solution to be supplemented according to the EC value detected by the EC value detector, and add the culture solution with the second target amount according to a preset ratio.

In one embodiment, a detector sends collected data to the controller of the regulating device, and the controller compares the collected data with a preset warning value, and when the collected data is more than or less than a preset warning value, the controller will issue a warning to remind the growth states of the crops.

The control method for preparing crop nutrient solution of the present disclosure calculates a proportion of the culture solution to be added to the crops according to collected growth stage sand growth states of the crops, and adjusts the culture solution of the crops efficiently and conveniently according to the proportion of the culture solution.

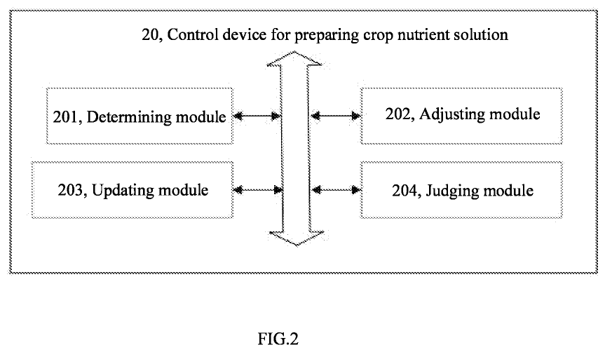

FIG. 2 illustrates a control device for preparing crop nutrient solution. The control device for preparing crop nutrient solution 20 includes a determining module 201, an adjusting module 202, an updating module 203 and a judging module 204. The module/unit of the present disclosure refers to a series of computer program segments that can be executed by a processor and can complete functions, and are stored in a storage device. In one embodiment, the functions of each module/unit will be described in detail in subsequent embodiments.

The determining module 201 determines the proportion of the nutrient solution required by the crops according to the growth states of the crops.

The adjusting module 202 adjusts the culture solution according to the proportion of the nutrient solution.

The updating module 203 determines updated growth states of the crops after a preset time period.

When the culture solution does not meet the proportion of the nutrient solution corresponding to the updated growth state, the judging module 204 adjusts the culture solution again until the culture solution meet the proportion of the nutrient solution corresponding to the growth state of the crops.

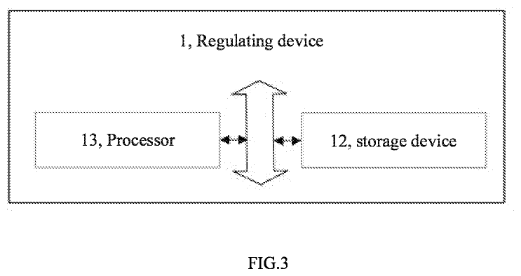

Referring to FIG. 3, the regulating device 1 includes, but is not limited to, a storage device 12, and a processor 13. Those skilled in the art can understand that the schematic structural diagram of FIG. 3 does not constitute a limitation on the regulating device 1, other examples may include more or less components than the one shown in FIG. 3, or the regulating device 1 combines some components, or has different components.

The regulating device 1 is a device that can automatically perform calculation of parameter value and/or information processing according to pre-set or stored instructions. In one embodiment, hardware of the regulating device 1 includes, but is not limited to a microprocessor, an Application Specific Integrated Circuit (ASIC), a Field-Programmable Gate Array (FPGA), a Digital Signal Processor (DSP), or an embedded device, etc.

In one embodiment, the regulating device 1 can be any electronic product that can interact with a user, such as a personal computer, a tablet computer, a smart phone, a Personal Digital Assistant (PDA), a game console, and an Internet Protocol Television (IP TV), a smart wearable device, etc.

In one embodiment, the regulating device 1 may also include a network equipment and/or a user equipment. In one embodiment, the network device includes, but is not limited to, a single network server, a server group consisting of multiple network servers, or a cloud computing-based cloud consisting of a large number of hosts or network servers.

In one embodiment, a network connected to the regulating device 1 includes, but is not limited to, the Internet, a wide area network, a metropolitan area network, a local area network, and a Virtual Private Network (VPN).

The processor 13 may be a central processing unit (CPU), or other general-purpose processors, a digital signal processor (DSP), an application specific integrated circuit (ASIC), Field-Programmable Gate Array (FPGA) or other programmable logic devices, discrete gate or transistor logic devices, discrete hardware components, etc. The general-purpose processor can be a microprocessor or the processor can also be any conventional processor, etc. The processor 13 is the computing core and control center of the regulating device 1, and uses various interfaces and lines to connect each part of the regulating device 1.

The storage device 12 can be used to store the computer programs and/or modules, and the processor 13 executes or obtains the computer programs and/or modules stored in the storage device 12, and calls up the data stored in the storage device 12, such that various functions of the regulating device 1 are realized. The storage device 12 may mainly include an area for storing programs and an area for storing data, wherein the area for storing programs may store an operating system, an application program required for at least one function (such as a sound playback function, an image playback function, etc.), and the like; the area for storing data may store the data created in the regulating device 1. In addition, the storage device 12 may include non-volatile storage device such as hard disk, internal memory, plug-in hard disk, smart media card (SMC), Secure digital (SD) card, flash card, at least one disk storage device, flash memory device, or other non-volatile solid state storage device.

The storage device 12 may be an external storage device and/or an internal storage device of the electronic device 1. Further, the storage device 12 may be a storage in physical form, such as a memory stick, a trans-flash card, and the like.

With reference to FIG. 3, the storage device 12 in the regulating device 1 stores a plurality of instructions to implement the method for classifying images, and the processor 13 can acquire the plurality of instructions to implement processes of: obtaining the growth data of the crops; according to a pre-established crop database, determining the growth states of the crops according to the growth data of the crops, and the crop database including the growth states of various crops in multiple growth stages and a proportion of nutrient solution corresponding to each of the growth states; determining the proportion of the nutrient solution required by the crops according to the growth states of the crops; adjusting the culture solution according to the proportion of the nutrient solution; determining updated growth states of the crops after a preset time period; when the culture solution does not meet the proportion of the nutrient solution corresponding to the updated growth state, adjusting the culture solution again until the culture solution meet the proportion of the nutrient solution corresponding to the growth state of the crops.

Specifically, for the specific implementation method of the above-mentioned instruction by the processor 13, reference may be made to the description of the relevant blocks in the corresponding embodiment of FIG. 1, and details are not repeated.

In the several embodiments provided in this disclosure, it should be understood that the devices and methods disclosed can be implemented by other means. For example, the device embodiments described above are only schematic. For example, the division of the modules is only by logical function, and can be implemented in another way.

The modules described as separate parts may or may not be physically separate, and the parts displayed as modules may or may not be physical units, that is, may be located in one place, or may be distributed over multiple network units. Part or all of the modules can be selected according to the actual needs to achieve the purpose of this embodiment.

In addition, each functional unit in each embodiment of the present disclosure can be integrated into one processing unit, or can be physically present separately in each unit, or two or more units can be integrated into one unit. The above integrated unit can be implemented in a form of hardware or in a form of a software functional unit.

The above integrated modules implemented in the form of function modules may be stored in a storage medium. The above function modules may be stored in a storage medium, and include several instructions to enable a computing device (which may be a personal computer, server, or network device, etc.) or processor to execute the method described in the embodiment of the present disclosure.

The present disclosure is not limited to the details of the above-described exemplary embodiments, and the present disclosure can be embodied in other specific forms without departing from the spirit or essential characteristics of the present disclosure. Therefore, the present embodiments are to be considered as illustrative and not restrictive, and the scope of the present disclosure is defined by the appended claims. All changes and variations in the meaning and scope of equivalent elements are included in the present disclosure. Any reference sign in the claims should not be construed as limiting the claim. Furthermore, the word “comprising” does not exclude other units nor does the singular exclude the plural. A plurality of units or devices stated in the system claims may also be implemented by one unit or device through software or hardware. Words such as “first” and “second” are used to indicate names but not to signify any particular order.

The above description only represents some embodiments of the present disclosure and is not intended to limit the present disclosure, and various modifications and changes can be made to the present disclosure. Any modifications, equivalent substitutions, improvements, etc. made within the spirit and scope of the present disclosure are intended to be included within the scope of the present disclosure.

What is claimed is:

1. A control method for preparing crop nutrient solution comprising:
obtaining growth data of crops;
determining a growth state of the crops according to corresponding growth data of the crops in a pre-established crop database, the pre-established crop database comprising growth states of a plurality kinds of crops in growth stages and a proportion of a nutrient solution corresponding to each of the growth states of each kind of the plurality kinds of crops;
determining a corresponding proportion of the nutrient solution according to the growth states of the kind of crops in the pre-established crop database;
adjusting the culture solution according to the corresponding proportion of the nutrient solution;
determining an updated growth state of the crops after a preset time period; and
in response that the culture solution does not meet a proportion of the nutrient solution corresponding to the updated growth state, adjusting the culture solution until the culture solution meets the proportion of the nutrient solution corresponding to the updated growth state of the crops.

2. The control method for preparing crop nutrient solution as recited in claim 1, wherein determining the updated growth state of the crops comprises:
detecting a change of a water level in a water tank where the crops are grown; and
in response that the water level in the water tank is lower than a preset water level threshold, obtaining growth images of the crops using an image acquisition device, identifying the growth images, wherein the growth data of the crops is obtained according to the growth images;
comparing the growth data of the crops with crop data in the crop database, and determining the growth state of the crops.

3. The control method for preparing crop nutrient solution as recited in claim 1, wherein determining the growth state of the crops according to the corresponding growth data of the crops in the pre-established crop database comprises:
determining a growth cycle and a health status of the crops according to the growth state of the crops; and
determining an optimized proportion of the nutrient solution according to the growth cycle and the health status of the crops.

4. The control method for preparing crop nutrient solution as recited in claim 2, wherein adjusting the culture solution until the culture solution meets the proportion of the nutrient solution corresponding to the updated growth state of the crops comprises:
adding water to the water tank;
adding one or more types of culture solution and preset chemicals to the water tank according to a preset proportion;
stirring the culture solution in the water tank; and
turning on a water cycle of the water tank for a preset time.

5. The control method for preparing crop nutrient solution as recited in claim 4, wherein when the culture solution does not meet the proportion of the nutrient solution corresponding to the updated growth state, adjusting the culture solution again until the culture solution meet the proportion of the nutrient solution corresponding to the growth state of the crops, comprises:
in response that a potential of hydrogen (PH) value of the culture solution is more than a first default value, adding sulfuric acid solution and reducing the PH value;
in response that the PH value is less than the first default value, adding water and increasing the PH value;
in response that an electrical conductivity (EC) value of the culture solution is more than a second default value, adding water and reducing the EC value; and
in response that the EC value of the culture solution is less than the second default value, adding one or more preset culture solutions according to a preset proportion.

6. The control method for preparing crop nutrient solution as recited in claim 2, further comprising:
detecting the water level in the water tank by using a water level monitor.

7. The control method for preparing crop nutrient solution as recited in claim 2, further comprising:
establishing a crop database according to characteristics, growth cycles, and health status of the crops.

8. A regulating device comprising:
a processor; and
a non-transitory storage medium coupled to the processor and configured to store a plurality of instructions, which cause the processor to:
obtain growth data of crops;
determine a growth state of the crops according to corresponding growth data of the crops in a pre-established crop database, the pre-established crop database comprising growth states of a plurality kinds of crops in growth stages and a proportion of a nutrient solution corresponding to each of the growth states of each kind of the plurality kinds of crops;
determine a corresponding proportion of the nutrient solution according to the growth states of the kind of crops in the pre-established crop database;
adjust the culture solution according to the corresponding proportion of the nutrient solution;
determine an updated growth state of the crops after a preset time period; and
in response that the culture solution does not meet a proportion of the nutrient solution corresponding to the updated growth state, adjust the culture solution until the culture solution meets the proportion of the nutrient solution corresponding to the updated growth state of the crops.

9. The regulating device as recited in claim 8, wherein the plurality of instructions are further configured to cause the processor to:
detect a change of a water level in a water tank where the crops are grown; and
in response that the water level in the water tank is lower than a preset water level threshold, obtain growth images of the crops using an image acquisition device, identify the growth images and obtain the growth data of the crops according to the growth images;
compare the growth data of the crops with crop data in the crop database, and determine the growth state of the crops.

10. The regulating device as recited in claim 8, wherein the plurality of instructions are further configured to cause the processor to:
determine a growth cycle and a health status of the crops according to the growth state of the crops; and
determine an optimized proportion of the nutrient solution according to the growth cycle and the health status of the crops.

11. The regulating device as recited in claim 9, wherein the plurality of instructions are further configured to cause the processor to:
add water to the water tank;
add one or more types of culture solution and preset chemicals to the water tank according to a preset proportion;
stir the culture solution in the water tank; and
turn on a water cycle of the water tank for a preset time.

12. The regulating device as recited in claim 11, wherein the plurality of instructions are further configured to cause the processor to:
in response that a potential of hydrogen (PH) value of the culture solution is more than a first default value, add sulfuric acid solution and reduce the pH value;
in response that the PH value is less than the first default value, add water and increase the PH value;
in response that an electrical conductivity (EC) value of the culture solution is more than a second default value, add water and reduce the EC value; and
in response that the EC value of the culture solution is less than the second default value, add one or more preset culture solutions according to a preset proportion.

13. The regulating device as recited in claim 9, wherein the plurality of instructions are further configured to cause the processor to:
detect the water level in the water tank by using a water level monitor.

14. The regulating device as recited in claim 9, wherein the plurality of instructions are further configured to cause the processor to:
establish a crop database according to characteristics, growth cycles, and health status of the crops.

15. A non-transitory storage medium having stored thereon instructions that, when executed by at least one processor of an electronic device, causes the least one processor to execute instructions of a control method for preparing crop nutrient solution, the method comprising:
obtaining growth data of crops;
determining a growth state of the crops according to corresponding growth data of the crops in a pre-established crop database, the pre-established crop database comprising growth states of various crops in growth stages and a proportion of a nutrient solution corresponding to each of the growth states of each kind of the plurality kinds of crops;
determining a corresponding proportion of the nutrient solution according to the growth states of the kind of crops in the pre-established crop database;
adjusting the culture solution according to the corresponding proportion of the nutrient solution;
determining an updated growth state of the crops after a preset time period; and
in response that the culture solution does not meet a proportion of the nutrient solution corresponding to the updated growth state, adjusting the culture solution until the culture solution meet the proportion of the nutrient solution corresponding to the updated growth state of the crops.

16. The non-transitory storage medium as recited in claim 15, wherein determining the updated growth state of the crops comprises:
detecting a change of a water level in a water tank where the crops are grown; and
in response that the water level in the water tank is lower than a preset water level threshold, obtaining growth images of the crops using an image acquisition device, identifying the growth images, wherein the growth data of the crops is obtained according to the growth images;
comparing the growth data of the crops with crop data in the crop database and determining the growth state of the crops.

17. The non-transitory storage medium as recited in claim 15, wherein determining the growth state of the crops according to the corresponding growth data of the crops in the pre-established crop database comprises:
determining a growth cycle and a health status of the crops according to the growth state of the crops; and
determining an optimized proportion of the nutrient solution according to the growth cycle and the health status of the crops.

18. The non-transitory storage medium as recited in claim 16, wherein adjusting the culture solution until the culture solution meets the proportion of the nutrient solution corresponding to the updated growth state of the crops comprises:
adding water to the water tank;
adding one or more types of culture solution and preset chemicals to the water tank according to a preset proportion;
stirring the culture solution in the water tank; and
turning on a water cycle of the water tank for a preset time.

19. The non-transitory storage medium as recited in claim 18, wherein when the culture solution does not meet the proportion of the nutrient solution corresponding to the updated growth state, adjusting the culture solution again until the culture solution meet the proportion of the nutrient solution corresponding to the growth state of the crops, comprises:
in response that a potential of hydrogen (PH) value of the culture solution is more than a first default value, adding sulfuric acid solution and reducing the PH value;
in response that the PH value is less than the first default value, adding water and increasing the PH value;
in response that an electrical conductivity (EC) value of the culture solution is more than a second default value, adding water and reducing the EC value; and
in response that the EC value of the culture solution is less than the second default value, adding one or more preset culture solutions according to a preset proportion.

20. The non-transitory storage medium as recited in claim 16, further comprising:
detecting the water level in the water tank by using a water level monitor.
